(19) United States
(12) Patent Application Publication
(10) Pub. No.: US 2021/0088706 A1
(43) Pub. Date: Mar. 25, 2021

(54) LENS ASSEMBLY

(71) Applicant: Newmax Technology Co., Ltd., Taichung City (TW)

(72) Inventors: Kuo-Fu Fan, Taichung City (TW); Hsin-Yu Lin, Taichung City (TW); Tsung-Chi Tsai, Taichung City (TW)

(21) Appl. No.: 16/579,439

(22) Filed: Sep. 23, 2019

(51) Int. Cl. G02B 5/28; G02B 13/00; G02B 1/04

(52) U.S. Cl. CPC G02B 5/28; G02B 1/041; G02B 13/002

(57) ABSTRACT

A lens assembly is provided, including: a barrel, at least one plastic lens and at least one coating film. The at least one plastic lens is assembled in the barrel. The at least one coating film is disposed on a surface of the at least one plastic lens and includes a plurality of coating layers which include at least one high refractive coating layer and at least one low refractive coating layer. A refractive index of the at least one high refractive coating layer is larger than a refractive index of the at least one low refractive coating layer. A thickness of each of the at least one coating film is larger than or equal to 3 micrometers.

### BACKGROUND OF THE INVENTION

### Field of the Invention

The present invention relates to a lens assembly.

### Description of the Prior Art

Generally, a lens assembly includes a barrel, a filter and a plurality of lenses which are assembled in the barrel. The filter, such as IR pass filter, IR cut filter or UV filter, is configured to cut off light with specific wavelength according to using requirements so as to protect the lens assembly, improve clarity of images or provide color correction or special photographic effects.

However, a conventional filter is made of a glass lens which is of high cost and occupies a space in the barrel, which results in a long length of the lens assembly and is not conductive to miniaturization.

The present invention is, therefore, arisen to obviate or at least mitigate the above-mentioned disadvantages.

### SUMMARY OF THE INVENTION

The main object of the present invention is to provide a lens assembly which is of low cost and has a small volume.

To achieve the above and other objects, the present invention provides a lens assembly, including: a barrel, at least one plastic lens and at least one coating film. The at least one plastic lens is assembled in the barrel. The at least one coating film is disposed on a surface of the at least one plastic lens and includes a plurality of coating layers which include at least one high refractive coating layer and at least one low refractive coating layer. A refractive index of the at least one high refractive coating layer is larger than a refractive index of the at least one low refractive coating layer. A thickness of each of the at least one coating film is larger than or equal to 3 micrometers.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferable embodiment of the present invention;

FIG. 2 is a cross-sectional view of the first preferable embodiment of the present invention;

FIG. 3 is a partial enlargement of the first preferable embodiment of the present invention;

FIG. 4 is a cross-sectional view of a second preferable embodiment of the present invention;

FIG. 5 is a cross-sectional view of a third preferable embodiment of the present invention.

### DETAILED DESCRIPTION OF THE PREFERRED EMBODIMENTS

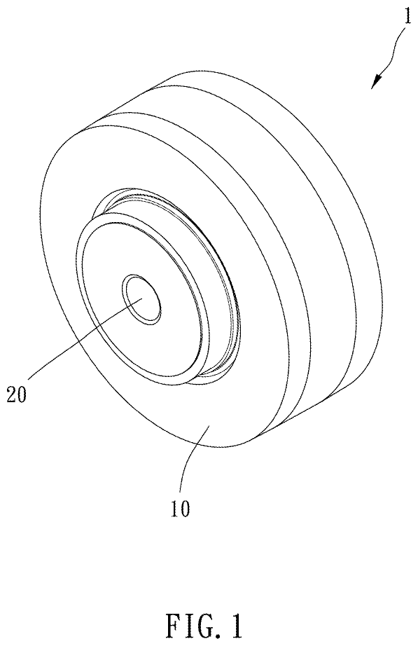

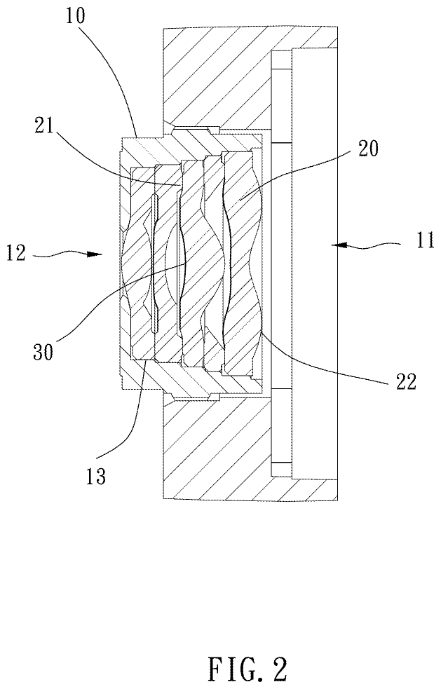

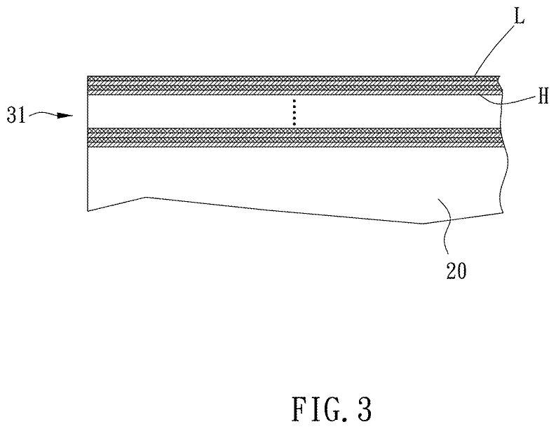

Please refer to FIGS. 1 to 3 for a first preferable embodiment of the present invention. A lens assembly 1 of the present invention includes a barrel 10, at least one plastic lens 20 and at least one coating film 30.

The at least one plastic lens 20 is assembled in the barrel 10. The at least one coating film 30 is disposed on a surface of the at least one plastic lens 20 and includes a plurality of coating layers 31 which include at least one high refractive coating layer H and at least one low refractive coating layer L. A refractive index of the at least one high refractive coating layer H is larger than a refractive index of the at least one low refractive coating layer L. A thickness of each of the at least one coating film 30 is larger than or equal to 3 micrometers. Therefore, the lens assembly 1 is of low cost and unnecessary to additionally set a filter lens therein, which can reduce components and have a small volume.

Each of the at least one high refractive coating layer H includes at least one high refractive material, and at least one of the at least one high refractive material, such as tantalum pentoxide (Ta₂O₅), niobium pentoxide (Nb₂O₅) or titanium dioxide (TiO₂), has a refractive index between 2.0 and 2.5. Each of the at least one low refractive coating layer L includes at least one low refractive material, and at least one of the at least one low refractive material, such as silicon dioxide (SiO₂), has a refractive index between 1.35 and 1.49. The plurality of coating layers 31 include a plurality of said high refractive coating layers H and a plurality of said low refractive coating layers L, every neighboring two of the plurality of coating layers 31 include one said high refractive coating layer H and one said low refractive coating layer L, and an outmost layer of the plurality of coating layers 31 is one of the plurality of said low refractive coating layers L. From the surface of the at least one plastic lens 20, the plurality of said high refractive coating layers H and the plurality of said low refractive coating layers L may be arranged in a LHLH . . . LHL or HLHL . . . HL manner according to various requirements, so as to provide different light filtration effects and be applicable to visible light lenses, infrared lenses or fingerprint recognition lenses, etc. In other embodiments, the plurality of coating layers may include coating layers having other values of the refractive index; the plurality of coating layers may be configured in other arrangements.

Preferably, each of the plurality of coating layers 31 of the at least one coating film 30 is a vapor-deposited layer, which is easy to process and provides high purity. Each of the at least one coating film 30 has a thickness between 3 and 5 micrometers; a number of the plurality of coating layers 31 is between 30 to 50 so that the at least one coating film 30 has high density and good filtration effect. The barrel 10 includes an object side 11 and an image side 12, and the at least one coating film 30 covers the surface of the at least one plastic lens 20 facing toward the image side 12, which avoids abrasion of the at least one coating film 30. In this embodiment, the lens assembly 1 includes a plurality of said plastic lenses 20 and a plurality of said coating films 30, and each of the plurality of said coating films 30 covers the surface of one of the plurality of said plastic lenses 20 facing toward the image side 12, so as to avoid abrasion and reduce effect on a path of incident light. However, the plurality of said coating films may be disposed on the surface of one of the plurality of said plastic lenses facing toward the object side.

At least one of the plurality of said plastic lenses 20 has an annular convex portion 21 protruding toward another one of the plurality of said plastic lenses 20 so that adjacent two of the plurality of said plastic lenses 20 have a clearance therebetween, which can avoid abrasion with each other and have an appropriate optical path. Each of the plurality of said plastic lenses 20 is an aspheric lens which includes at least one curved surface 22 having a radius of central curvature equal to or larger than 10 mm. Preferably, each said curved surface 22 of the plurality of said plastic lenses 20 has a radius of central curvature equal to or larger than 10 mm, which reduces aberrations and avoids imaging distortion. An inner circumferential wall of the barrel 10 includes a plurality of annular circumferential walls 13 which are stepped, and diametric dimensions of the plurality of said plastic lenses 20 are gradually decreased in a direction toward the image side 12. Each of the plurality of said plastic lenses 20 corresponds to and is radially abuttable against one of the plurality of annular circumferential walls 13 so that the plurality of said plastic lenses 20 can be stably assembled.

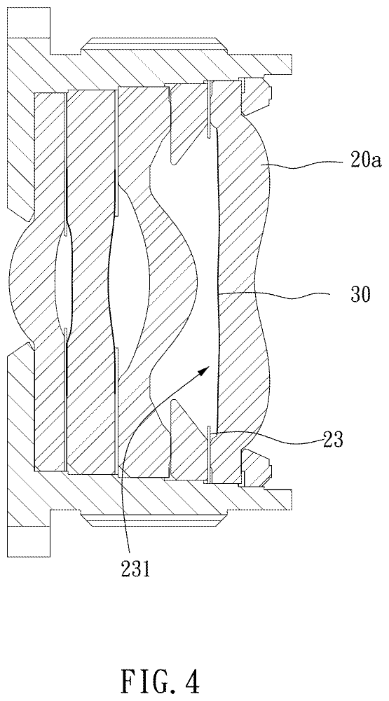

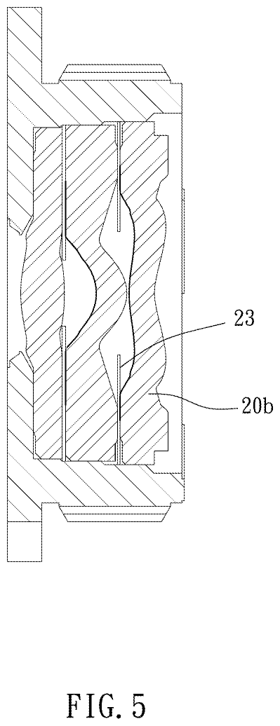

Please refer to FIG. 4 for a second preferable embodiment of the present invention. Adjacent two of the plurality of said plastic lenses 20a are arranged with a shielding plate 23 disposed therebetween and defining a through hole 231 which is, as viewed in an axial direction of the barrel 10, located entirely within an area of one of the plurality of said coating films 30 adjacent to the shielding plate 23, so as to have effective filtration effect, concentrate the optical path and reduce stray light to avoid interference for better imaging effect. However, any adjacent two of the plurality of said plastic lenses 20b may be arranged with one of said shielding plate 23 disposed therebetween, as shown in FIG. 5.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A lens assembly, including:
a barrel;
at least one plastic lens, assembled in the barrel;
at least one coating film, disposed on a surface of the at least one plastic lens, including a plurality of coating layers which include at least one high refractive coating layer and at least one low refractive coating layer, a refractive index of the at least one high refractive coating layer being larger than a refractive index of the at least one low refractive coating layer, a thickness of each of the at least one coating film being larger than or equal to 3 micrometers.

2. The lens assembly of claim 1, wherein each of the at least one high refractive coating layer includes at least one high refractive material, and at least one of the at least one high refractive material has a refractive index between 2.0 and 2.5.

3. The lens assembly of claim 1, wherein each of the at least one low refractive coating layer includes at least one low refractive material, and at least one of the at least one low refractive material has a refractive index between 1.35 and 1.49.

4. The lens assembly of claim 1, wherein each of the at least one plastic lens is an aspheric lens which includes at least one curved surface having a radius of central curvature equal to or larger than 10 mm.

5. The lens assembly of claim 1, wherein the plurality of coating layers include a plurality of said high refractive coating layers and a plurality of said low refractive coating layers, every neighboring two of the plurality of coating layers include one said high refractive coating layer and one said low refractive coating layer, and an outmost layer of the plurality of coating layers is one of the plurality of said low refractive coating layers.

6. The lens assembly of claim 1, wherein each of the at least one coating film has a thickness between 3 and 5 micrometers.

7. The lens assembly of claim 1, wherein a number of the plurality of coating layers is between 30 and 50.

8. The lens assembly of claim 1, wherein the barrel includes an object side and an image side, and the at least one coating film covers the surface of the at least one plastic lens facing toward the image side.

9. The lens assembly of claim 1, including a plurality of said plastic lenses, wherein adjacent two of the plurality of said plastic lenses are arranged with a shielding plate disposed therebetween and defining a through hole which is, as viewed in an axial direction of the barrel, located entirely within an area of one of the at least one coating film adjacent to the shielding plate.

10. The lens assembly of claim 5, wherein each of the plurality of said high refractive coating layers includes at least one high refractive material, and at least one of the at least one high refractive material has a refractive index between 2.0 and 2.5; each of the plurality of said low refractive coating layers includes at least one low refractive material, and at least one of the at least one low refractive material has a refractive index between 1.35 and 1.49; each of the at least one plastic lens is an aspheric lens which includes at least one curved surface having a radius of central curvature equal to or larger than 10 mm; each of the at least one coating film has a thickness between 3 and 5 micrometers; a number of the plurality of coating layers is between 30 and 50; the barrel includes an object side and an image side, and the at least one coating film covers the surface of the at least one plastic lens facing toward the image side; each of the plurality of coating layers of the at least one coating film is a vapor-deposited layers; the lens assembly includes a plurality of said plastic lenses, at least one of the plurality of said plastic lenses has an annular convex portion protruding toward another one of the plurality of said plastic lenses; an inner circumferential wall of the barrel includes a plurality of annular circumferential walls which are stepped, diametric dimensions of the plurality of said plastic lenses are gradually decreased in a direction toward the image side, each of the plurality of said plastic lenses corresponds to and is radially abuttable against one of the plurality of annular circumferential walls.
